(19) United States
(12) Patent Application Publication
(10) Pub. No.: US 2023/0202012 A1
(43) Pub. Date: Jun. 29, 2023

(54) Target Illuminating Stapling Device And Method Of Use

(71) Applicant: Jeremy Peters, St. Peters, MO (US)

(72) Inventor: Jeremy Peters, St. Peters, MO (US)

(21) Appl. No.: 17/563,198

(22) Filed: Dec. 28, 2021

(51) Int. Cl. B25C 7/00; B25C 5/16; F21V 33/00

(52) U.S. Cl. CPC B25C 7/00; B25C 5/1686; F21V 33/0084

(57) ABSTRACT

A target illuminating stapling device for safely fastening an item to a substrate includes a staple gun and a bulb. The staple gun comprises a staple driver, a handle, and a staple cartridge. The staple driver is positioned in a front portion of the staple gun. The handle is hingedly engaged to the front portion and extends over a back portion of the staple gun. The handle is operationally engaged to the staple driver. Levering of the handle actuates the staple driver to fasten a staple into a substrate. An item that is positioned between the staple and the substrate is fastened to the substrate. The staple cartridge selectively feeds the staple to the staple driver. The bulb is engaged to the staple gun proximate to the staple driver. The bulb selectively illuminates a target area of the substrate into which the staple is to be fastened.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stapling devices and more particularly pertains to a new stapling device for safely fastening an item to a substrate. The present invention discloses a stapling device comprising a staple gun having a bulb which allows a user to selectively illuminate a target area where a staple is to be fastened.

### (2) Description of Related Art Including Information Disclosed Under 37 CFR 1.97 and 1.98

The prior art relates to stapling devices. Such stapling devices have a variety of configurations, such as stapling devices equipped with wire guides to guide staples around wires. What is lacking in the prior art is a stapling device comprising a staple gun having a bulb which allows a user to selectively illuminate a target area where a staple is to be fastened.

### BRIEF SUMMARY OF THE INVENTION

An embodiment of the disclosure meets the needs presented above by generally comprising a staple gun and a bulb. The staple gun comprises a staple driver, a handle, and a staple cartridge. The staple driver is positioned in a front portion of the staple gun. The handle is hingedly engaged to the front portion and extends over a back portion of the staple gun. The handle is operationally engaged to the staple driver. Levering of the handle toward the back portion actuates the staple driver to fasten a staple into a substrate. An item that is positioned between the staple and the substrate is fastened to the substrate. The staple cartridge is positioned in the staple gun and extends along a bottom of the staple gun. The staple cartridge is configured to selectively feed the staple to the staple driver. The bulb is engaged to the staple gun proximate to the staple driver. The bulb is configured to selectively illuminate a target area of the substrate into which the staple is to be fastened.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a target illuminating stapling device according to an embodiment of the disclosure.

FIG. 2 is a side view of an embodiment of the disclosure.

FIG. 3 is a front view of an embodiment of the disclosure.

FIG. 4 is a bottom view of an embodiment of the disclosure.

FIG. 5 is a partial cross-sectional view of an embodiment of the disclosure.

FIG. 6 is a partial cross-sectional view of an embodiment of the disclosure.

FIG. 7 is an in-use view of an embodiment of the disclosure.

FIG. 8 is a flow diagram for a method utilizing an embodiment of the disclosure.

### DETAILED DESCRIPTION OF THE INVENTION

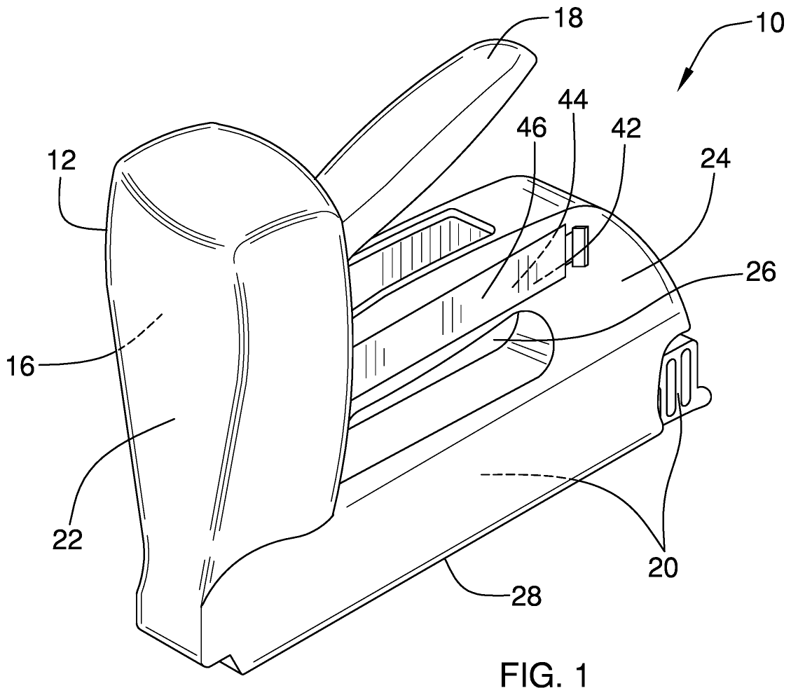

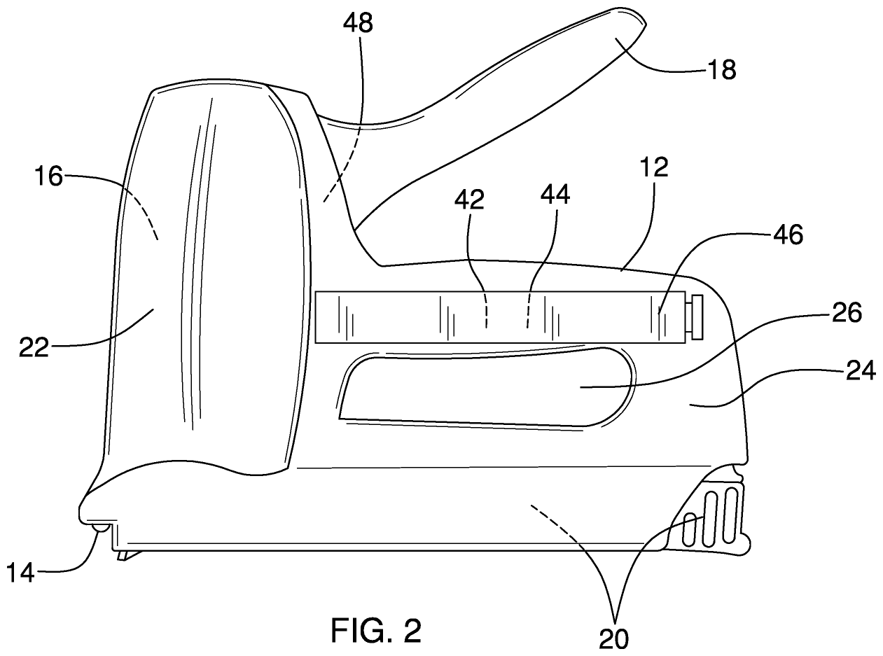

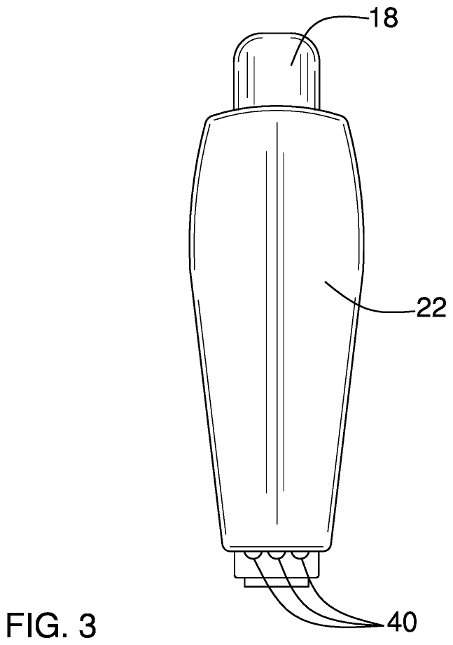

With reference now to the drawings, and in particular to FIGS. 1 through 8 thereof, a new stapling device embodying the principles and concepts of an embodiment of the disclosure and generally designated by the reference numeral 10 will be described.

As best illustrated in FIGS. 1 through 8, the target illuminating stapling device 10 generally comprises a staple gun 12 and a bulb 14. The staple gun 12 comprises a staple driver 16, a handle 18, and a staple cartridge 20. The staple driver 16 is positioned in a front portion 22 of the staple gun 12. The handle 18 is hingedly engaged to the front portion 22 and extends over a back portion 24 of the staple gun 12. The handle 18 is operationally engaged to the staple driver 16. An aperture 26 is positioned in the back portion 24 of the staple driver 16. The aperture 26 is configured for positioning of digits of a hand of a user. The user then is positioned to tighten a grip upon the handle 18 to actuate the staple driver 16. The staple cartridge 20 is positioned in the staple gun 12 and extends along a bottom 28 of the staple gun 12. The staple cartridge 20 is configured to selectively feed a staple 30 to the staple driver 16.

Levering of the handle 18 toward the back portion 24 actuates the staple driver 16 to fasten the staple 30 into a substrate 32. An item 34 that is positioned between the staple 30 and the substrate 32 is fastened to the substrate 32. The bulb 14 is engaged to the staple gun 12 proximate to the staple driver 16. The bulb 14 is configured to selectively illuminate a target area 36 of the substrate 32 into which the staple 30 is to be fastened. The present invention is anticipated to be of use in fulfilling a variety of fastening tasks. For example, the target illuminating stapling device 10 is useful in fastening a low voltage wire 38 to a substrate 32, such as a wall or a ceiling. The bulb 14 illuminates both the low voltage wire 38 and the target area 36 of the substrate 32, minimizing a risk of damage to the low voltage wire 38 during stapling.

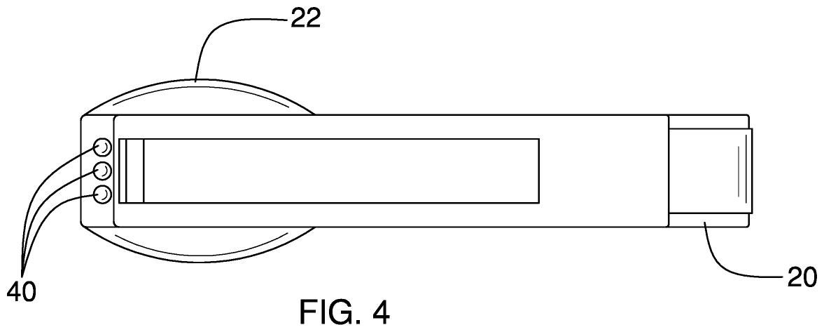

The bulb 14 may comprise a set of light emitting diodes 40, or other illuminating means, such as, but not limited to, lasers, incandescent lights, and the like. The set of light emitting diodes 40 comprises at least two light emitting diodes 40. The set of light emitting diodes 40 may comprise three light emitting diodes 40, as shown in FIG. 4.

A battery 42 is positioned in the staple gun 12 and is operationally engaged to the bulb 14, thus positioning the battery 42 to selectively power the bulb 14. An opening 44 is positioned in the staple gun 12 proximate to the battery 42. The opening 44 is configured to allow access the battery 42. A panel 46 is selectively couplable to the staple gun 12 to close the opening 44. The present invention anticipates the battery 42 being integral to the staple gun 12 and rechargeable by means of a port and charging cable (not shown). The present invention also anticipate the staple gun 12 being electrically or pneumatically powered.

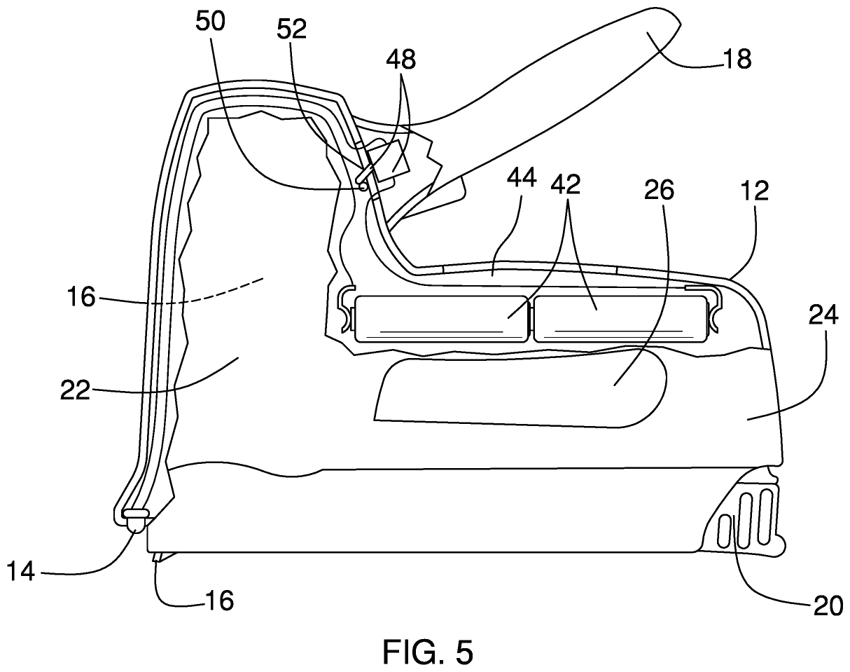

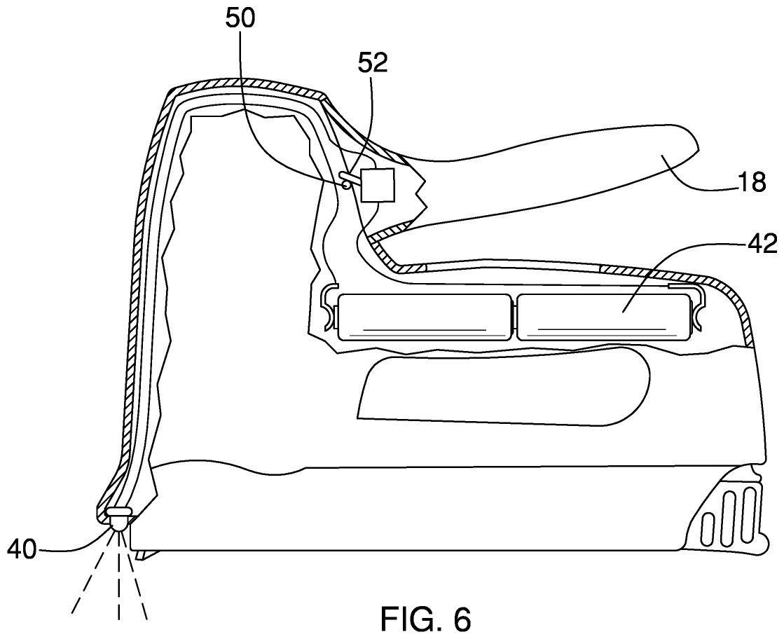

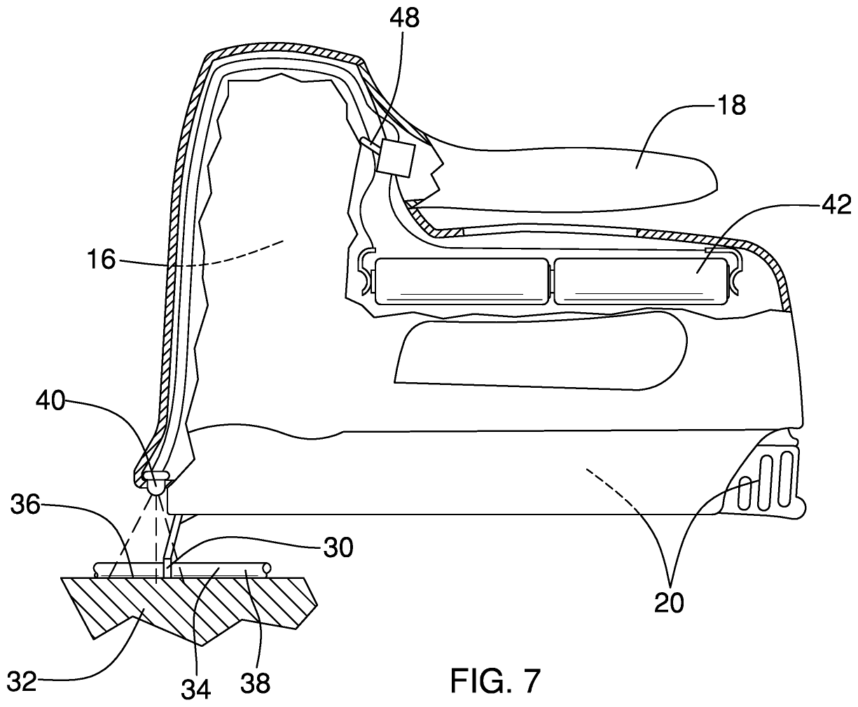

A switch 48 is engaged to the handle 18 and is configured to be switched upon levering of the handle 18 relative to the back portion 24. The switch 48 is operationally engaged to the bulb 14 and the battery 42. The bulb 14 is operationally engaged to the battery 42 upon levering of the handle 18 toward the back portion 24, as shown in FIGS. 6 and 7, and disengaged from the battery 42 upon return of the handle 18 to a position distal from the back portion 24, as shown in FIG. 5.

The switch 48 may comprise a first contact 50 and a second contact 52, as shown in FIG. 5. The first contact 50 is engaged to the front portion 22. The second contact 52 is hingedly engaged to the handle 18 and remains in contact with the first contact 50 as the lever approaches the back portion 24. The present invention anticipates the switch 48 comprising other switching means, or modes of operation. For example, a sensor (not shown) engaged to the handle 18 or to the staple gun 12 within the aperture 26 might detect positioning of a hand on the handle 18 or fingers within the aperture 26, respectively, whereupon a signal is sent to the switch 48 to actuate the bulb 14.

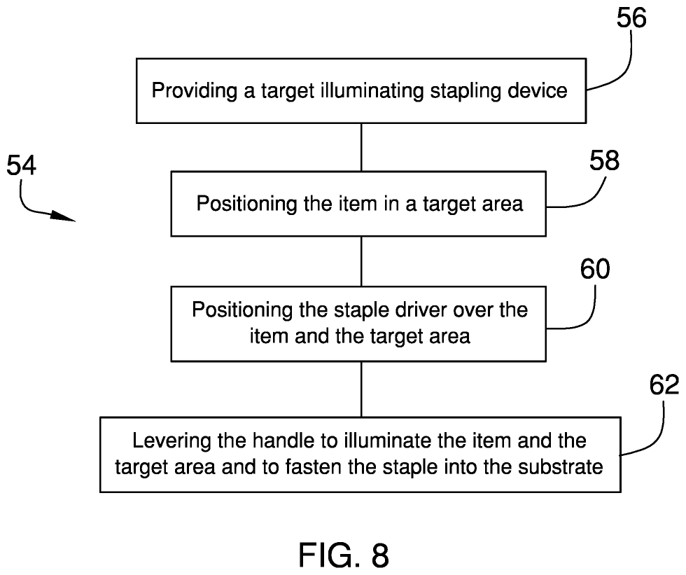

In use, the target illuminating stapling device 10 enables a method 54 of illuminating and fastening an item to a substrate using a staple. As shown in FIG. 8, the method 54 comprises a first step 56 of providing a target illuminating stapling device 10 according to the specification above. A second step 58 of the method 54 is positioning the item 34 in the target area 36. A third step 60 of the method 54 is positioning the staple driver 16 over the item 34 and the target area 36. A fourth step 62 of the method 54 is levering the handle 18 to illuminate the item 34 and the target area 36 and to fasten the staple 30 into the substrate 32 so that the item 34 is engaged to the substrate 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A target illuminating stapling device comprising:
a staple gun comprising:
a staple driver positioned in a front portion of the staple gun,
a handle hingedly engaged to the front portion and extending over a back portion of the staple gun, the handle being operationally engaged to the staple driver, such that levering of the handle toward the back portion actuates the staple driver for fastening a staple into a substrate, such that an item positioned between the staple and the substrate is fastened to the substrate, and
a staple cartridge positioned in the staple gun and extending along a bottom of the staple gun, the staple cartridge being configured for selectively feeding the staple to the staple driver; and
a bulb engaged to the staple gun proximate to the staple driver, wherein the bulb is configured for illuminating a target area of the substrate into which the staple is to be fastened including directly illuminating a position where the staple is to be fastened while the staple driver is positioned in alignment with the position where the staple is to be fastened.

2. The target illuminating stapling device of claim 1, further including an aperture positioned in the back portion of the staple driver, wherein the aperture is configured for positioning of digits of a hand of a user, positioning the user for tightening a grip upon the handle for actuating the staple driver.

3. The target illuminating stapling device of claim 1, wherein the bulb comprises a set of light emitting diodes.

4. The target illuminating stapling device of claim 3, wherein the set of light emitting diodes comprises at least two light emitting diodes.

5. The target illuminating stapling device of claim 4, wherein the set of light emitting diodes comprises three tight emitting diodes.

6. The target illuminating stapling device of claim 1, further including:
a battery positioned in the staple gun and being operationally engaged to the bulb, such that the battery is positioned for selectively powering the bulb; and
a switch engaged to the handle and being configured for switching upon levering of the handle relative to the back portion, the switch being operationally engaged to the bulb and the battery, such that the bulb is operationally engaged to the battery upon levering of the handle toward the back portion and disengaged from the battery upon return of the handle to a position distal from the back portion.

7. The target illuminating stapling device of claim 6, further including:
an opening positioned in the staple gun proximate to the battery, wherein the opening is configured for accessing the battery; and
a panel selectively couplable to the staple gun for closing the opening.

8. The target illuminating stapling device of claim 6, wherein the switch comprises:
a first contact engaged to the front portion; and
a second contact hingedly engaged to the handle, such that the second contact remains in contact with the first contact as the lever approaches the back portion.

9. A method of illuminating and fastening a staple to a target, the method comprising the steps of:
providing a target illuminating stapling device comprising:
a staple gun comprising:
a staple driver positioned in a front portion of the staple gun,
a handle hingedly engaged to the front portion and extending over a back portion of the staple gun, the handle being operationally engaged to the staple driver, such that levering of the handle toward the back portion actuates the staple driver for fastening a staple into a substrate, such that an item positioned between the staple and the substrate is fastened to the substrate, and
a staple cartridge positioned in the staple gun and extending along a bottom of the staple gun, the staple cartridge being configured for selectively feeding the staple to the staple driver, and
a bulb engaged to the staple gun proximate to the staple driver, wherein the bulb is configured for illuminating a target area of the substrate into which the staple is to be fastened including directly illuminating a position where the staple is to be fastened while the staple driver is positioned in alignment with the position where the staple is to be fastened;
positioning the item in a target area;
positioning the staple driver over the item and the target area; and
levering the handle for illuminating the item and the target area and for fastening the staple into the substrate.

10. A target illuminating stapling device comprising:
a staple gun comprising:
a staple driver positioned in a front portion of the staple gun,
a handle hingedly engaged to the front portion and extending over a back portion of the staple gun, the handle being operationally engaged to the staple driver, such that levering of the handle toward the back portion actuates the staple driver for fastening a staple into a substrate, such that an item positioned between the staple and the substrate is fastened to the substrate,
a staple cartridge positioned in the staple gun and extending along a bottom of the staple gun, the staple cartridge being configured for selectively feeding the staple to the staple driver, and
an aperture positioned in the back portion of the staple driver, wherein the aperture is configured for positioning of digits of a hand of a user, positioning the user for tightening a grip upon the handle for actuating the staple driver;
a bulb engaged to the staple gun proximate to the staple driver, wherein the bulb is configured for selectively illuminating a target area of the substrate into which the staple is to be fastened including directly illuminating a position where the staple is to be fastened while the staple driver is positioned in alignment with the position where the staple is to be fastened, the bulb comprising a set of light emitting diodes, the set of light emitting diodes comprising at least two light emitting diodes, the set of light emitting diodes comprising three light emitting diodes;
a battery positioned in the staple gun and being operationally engaged to the bulb, such that the battery is positioned for selectively powering the bulb;
an opening positioned in the staple gun proximate to the battery, wherein the opening is configured for accessing the battery;
a panel selectively couplable to the staple gun for closing the opening; and
a switch engaged to the handle and being configured for switching upon levering of the handle relative to the back portion, the switch being operationally engaged to the bulb and the battery, such that the bulb is operationally engaged to the battery upon levering of the handle toward the back portion and disengaged from the battery upon return of the handle to a position distal from the back portion, the switch comprising a first contact engaged to the front portion and a second contact hingedly engaged to the handle, such that the second contact remains in contact with the first contact as the lever approaches the back portion.
